(19) United States
(12) Patent Application Publication
(10) Pub. No.: US 2011/0041347 A1
(43) Pub. Date: Feb. 24, 2011

(54) PET HAIR TRIMMING CUTTER

(76) Inventor: Hou-Pia Wang, Chang-Hua City (TW)

Correspondence Address: Brinks Hofer Gilson & Lione/Ann Arbor, 524 South Main Street, Suite 200, Ann Arbor, MI, 48104, US

(21) Appl. No.: 12/939,389

(22) Filed: Nov. 4, 2010

Related U.S. Application Data
(63) Continuation-in-part of application No. 12/119,977, filed on May 13, 2008.

(51) Int. Cl. B26B 21/40

(52) U.S. Cl. 30/233.5

(57) ABSTRACT

A pet hair trimming cutter includes a plate body, a plurality of teeth and a plurality of blade elements. The plate body has two opposite plate faces, and an edge face interconnecting ends of the plate faces. The teeth are spaced apart from each other and connected to the edge face. Each tooth has root and tip portions. Each blade element is connected to the edge face, and the root portions of two adjacent teeth. Each blade element has two opposite inclined blade faces, which extends convergingly and respectively from the ends of the plate faces and merge into a blade edge opposite to the edge face of the plate body.

### CROSS-REFERENCE TO RELATED APPLICATION

This application is a C-I-P application of U.S. patent application Ser. No. 12/119,977 filed on May 13, 2008.

### BACKGROUND OF THE INVENTION

1. Field of the Invention

The invention relates to a hair trimming cutter, and more particularly to a pet hair trimming cutter.

2. Description of the Related Art

A conventional pet hair trimming cutter, such as those disclosed in U.S. Pat. No. 441,136, U.S. Pat. No. 6,782,846B1, and WO2009/033099A1, etc., include a plurality of spaced apart teeth formed on a plate body, and a plurality of blades connected to root portions of the teeth. Each blade includes two opposite blade faces one of which is co-planar with one side face of the plate body. The other blade face is inclined with the plane of the other side face of the plate body.

While the foregoing conventional pet hair trimming cutter can comb away loose hair through the blades, the blades are very ineffective for thinning of the pet's hair.

Moreover, for pets with intertwining long hair, the foregoing conventional pet hair trimming cutters are unable to open and trim the intertwining hair.

### SUMMARY OF THE INVENTION

An object of the present invention is to provide a pet hair trimming cutter that facilitates thinning of hair and dealing with intertwined hair.

Accordingly, a pet hair trimming cutter comprises: a plate body having two opposite plate faces, and an edge face transverse to and interconnecting ends of the opposite plate faces; a plurality of teeth spaced apart from each other and projecting from the edge face. Each of the teeth includes a root portion proximate to the edge face and a tip portion distal from the edge face. A plurality of blade elements are connected to the edge face. Each of the blade elements is disposed between and connected to the root portions of two adjacent ones of the teeth, and includes two opposite inclined blade faces, which extend convergingly and respectively from the ends of the plate faces, and which merge into a cutting edge opposite to the edge face of the plate body. Both of the inclined blade faces are inclined with respect to the plate faces.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a pet hair trimming cutter according to a preferred embodiment of the present invention;

FIG. 2 is a fragmentary enlarged view of the pet hair trimming cutter;

FIG. 3 is a side sectional view illustrating one of the teeth and one of the blade elements of the pet hair trimming cutter; and

FIG. 4 is a sectional view illustrating the pet hair trimming cutter mounted on a handle.

### DETAILED DESCRIPTION OF THE PREFERRED EMBODIMENTS

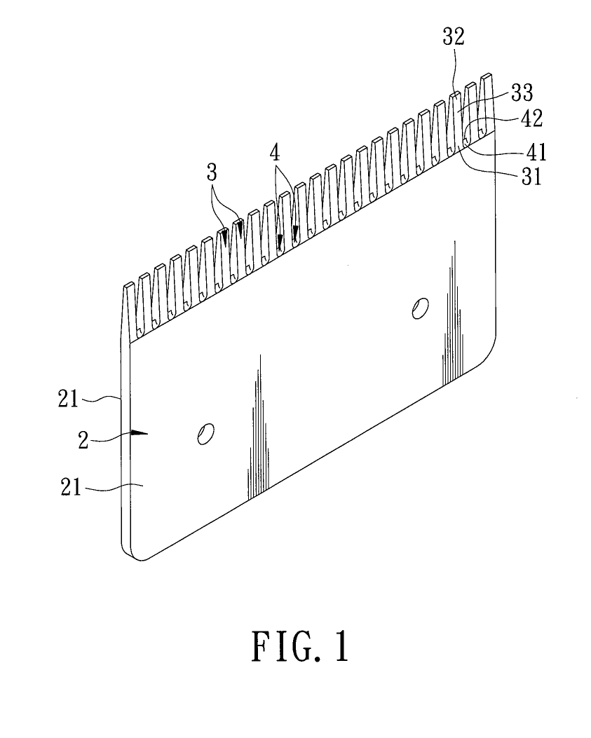

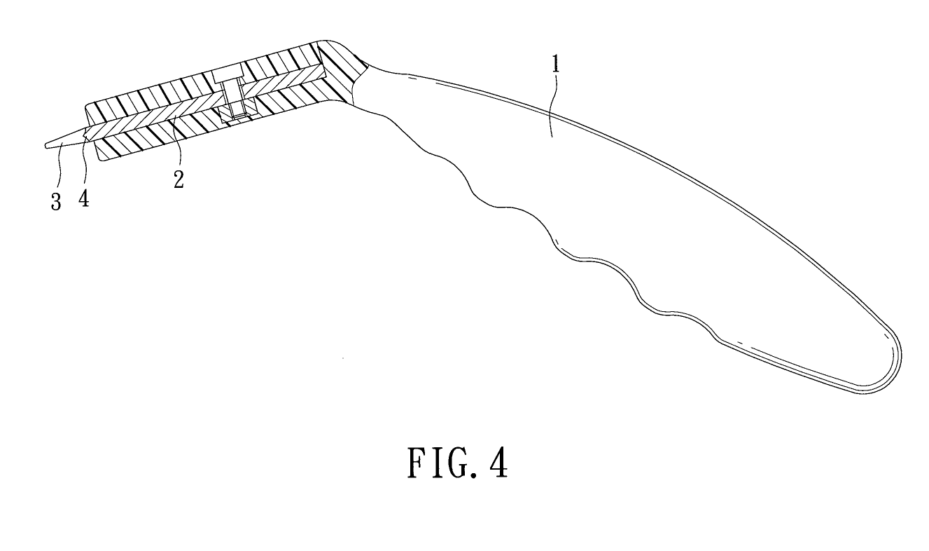

Referring to FIGS. 1 and 4, a pet hair trimming cutter according to a preferred embodiment of the present invention is shown as being mounted on a handle 1 and includes a plate body 2, a plurality of teeth 3 and a plurality of blade elements 4.

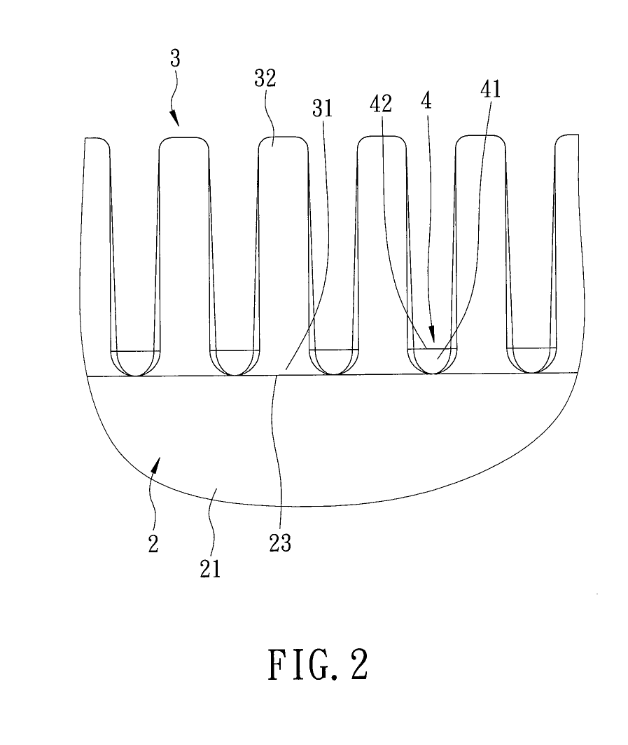

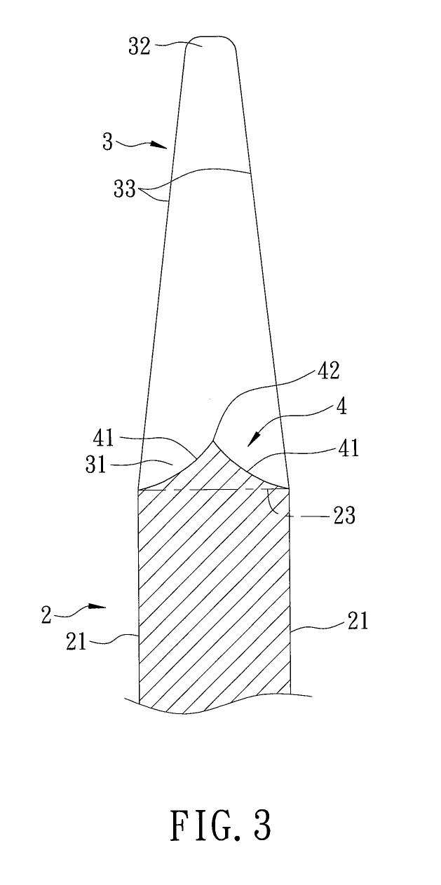

Referring to FIGS. 2 and 3, the plate body 2 has a rectangular shape and includes two opposite plate faces 21, and an edge face 23 connected between and transverse to the plate faces 21.

The teeth 3 are spaced apart from each another and connected to the edge face 23. The plate body 2 is formed integrally with the teeth 3. Each of the teeth 3 includes a root portion 31 proximate to the edge face side 23 and a tip portion 32 distal from the edge face 23. In this embodiment, for each of the teeth 3, the width of the tip portion 32 is smaller than that of the root portion 31. In particular, each tooth 3 has opposite tooth faces 33 that extend respectively from ends of the plate faces 21 and tapers toward the corresponding tip portion 32, forming a symmetric frusto-conical shape. With the tapering tip portions 32, the teeth 3 can be extended easily into to the depth of hair.

The blade elements 4 are connected to the edge face 23 of the plate body 2, and are formed integrally with the teeth 3 and the plate body 2. Each of the blade elements 4 is disposed between and connected to the root portions 31 of two adjacent ones of the teeth 3.

Each of the blade element 4 includes two opposite inclined blade faces 41, which extend convergingly and respectively from ends of the plate faces 21, and which merge into a cutting edge 42 opposite to the edge face 22 of the plate body 2. Thus, each blade element 4 has the blade faces 41 thereof inclined with the planes of the respective plate faces 22. Since each blade element 4 has two inclined blade faces 41, compared to the blade of the conventional pet hair trimming cutter that has a single inclined blade face, the blade elements 4 according to the present invention are more effective for thinning the pets' hair and cutting the pet's intertwining hair. Preferably, in this embodiment, each of the inclined blade faces 41 of each blade element 4 has a concave curved surface such that the blade edge 42 is sharp and more effective in cutting the pet's hair.

In sum, apart from combing away loose hair, the pet hair trimming cutter of this invention can thin a pet's hair and cut intertwined hair. Moreover, because the blade faces 41 of each blade element 4 of this invention have concave curved surfaces, the blade edge 42 is sharper than that of the blade of the conventional hair trimming cutter.

While the present invention has been described in connection with what is considered the most practical and preferred embodiment, it is understood that this invention is not limited to the disclosed embodiments but is intended to cover various arrangement included within the spirit and scope of the broadest interpretation so as to encompass all such modifications and equivalent arrangements.

What is claimed is:

1. A pet hair trimming cutter comprising:
a plate body having two opposite plate faces, an edge face transverse to and interconnecting ends of said opposite plate faces;
a plurality of teeth spaced apart from each other and projecting from said edge face, each of said teeth including a root portion proximate to said edge face and a tip portion distal from said edge face; and
a plurality of blade elements connected to said edge face, each of said blade elements being disposed between and connected to said root portions of two adjacent ones of said teeth, and including two opposite inclined blade faces, which extend convergingly and respectively from said ends of said plate faces, and which merge into a cutting edge opposite to said edge face of said plate body, both of said inclined blade faces being inclined with respect to planes of said plate faces.

2. The pet hair trimming cutter of claim 1, wherein said plate body and said blade faces are integrally interconnected.

3. The pet hair trimming cutter of claim 2, wherein said teeth and said blade faces are integrally interconnected.

4. The pet hair trimming cutter of claim 1, wherein each of said inclined blade faces of each of said blade elements has a concave curved surface.

5. The pet hair trimming cutter of claim 1, wherein said tip portion has a width smaller than that of said root portion.

6. The pet hair trimming cutter of claim 5, wherein each of said teeth includes two opposite tooth faces that extend respectively from said ends of said plate faces and that taper toward said tip portion of the corresponding one of said teeth.
